(19) United States
(12) Patent Application Publication
(10) Pub. No.: US 2012/0166966 A1
(43) Pub. Date: Jun. 28, 2012

(54) USER INTERFACE FOR MULTIPLE USERS

(75) Inventors: David Wood, Bacoa Raton, FL (US); Nick Metianu, Boca Raton, FL (US); Amy Mikolasy, Boca Raton, FL (US); Joshua Aron Bass, Parkland, FL (US)

(73) Assignee: OpenPeak, Inc., Boca Raton, FL (US)

(21) Appl. No.: 13/280,548

(22) Filed: Oct. 25, 2011

Related U.S. Application Data
(60) Provisional application No. 61/406,313, filed on Oct. 25, 2010.

(51) Int. Cl. G06F 3/048

(52) U.S. Cl. 715/750

(57) ABSTRACT

A multi-media device and accompanying method of use are described herein. The device includes a housing, a display that is integrated within the housing and a processor. The processor can be operable to cause a user interface for multiple users to be displayed on the display. The user interface can include a user indicator that selectively displays a representation of each user associated with the multi-media device and provides a selection mechanism that provides a way for a user to select a particular representation. The user interface can also include a scrolling mechanism. When activated, the scrolling mechanism can cause the user indicator to selectively display the representations of the users based on a manner in which the scrolling mechanism is activated.

### CROSS-REFERENCE TO RELATED APPLICATIONS

This application claims the benefit of U.S. Provisional Patent Application No. 61/406,313, filed Oct. 25, 2010, the entirety of which is incorporated by reference herein.

### FIELD OF TECHNOLOGY

The subject matter herein is directed to a user interface and more particularly, to a user interface for multiple users of a multi-media device.

### BACKGROUND

Today's computing devices are packed with numerous features, and many of them include a home page that displays several icons representing applications that may be launched or accessed by a user. These devices typically allow the user to arrange his/her home page according to that person's individual tastes. In recent years, there has been a movement to incorporate multiple accounts into computing devices as a convenient way to allow multiple users to access and use the same machine. Although useful, having multiple accounts complicates the operation of computing devices because each user has a different home page set-up and disparate settings and parameters. Moreover, because multiple accounts may be implemented on a single device, there are security concerns to consider.

### SUMMARY

A multi-media device and accompanying method of use are described herein. The device can include a housing, a display that is integrated within the housing and a processor. The processor can be operable to cause a user interface for multiple users to be displayed on the display. The user interface can include a user indicator that can selectively display a representation of each user associated with the multi-media device and can provide a selection mechanism that can provide a way for a user to select a particular representation. The user interface can also include a scrolling mechanism. When activated, the scrolling mechanism may cause the user indicator to selectively display the representations of the users based on a manner in which the scrolling mechanism is activated.

The processor can be further operable to selectively cause a profile to be activated based on a representation selected through the selection mechanism. In addition, the device can further include a confirmation indicator that can identify which of the representations of the users is associated with the activated profile. As an example, the activated profile is a profile that is currently displayed by the display, and the currently displayed profile can be associated with a representation that was the last representation selected through the selection mechanism. As another example, the profile is a user home page that includes one or more predefined settings.

In one arrangement, the scrolling mechanism can include a set of opposing activators that when activated, cause the user indicator to display representations of the users in a manner that is associated with the activator that is activated. For example, the activators are arrowheads that point in opposite directions such that when activated, a sequence of representations of users is displayed in an order set by the particular arrowhead that is activated.

The processor can be further operable to cause a security feature to be presented when a particular representation is selected through the selection mechanism. As an example, the security feature is a prompt that seeks an authorized passcode that is associated with the particular representation that is selected.

A method of selecting a profile through a user interface on a multi-media device is also described herein. The method can include the steps of providing a user indicator that selectively displays a representation of each user associated with the multi-media device in which each user has a profile for the multi-media device and providing a selection mechanism to enable a user to select a particular representation. The method can also include the step of providing a scrolling mechanism such that when the scrolling mechanism is activated, the user indicator selectively displays the representations of the users associated with the multi-media device based on a manner in which the scrolling mechanism is activated.

As part of the method, a profile based on a representation that is selected through the selection mechanism can be activated and a confirmation indicator that identifies which of the representations of the users is associated with the activated profile can be displayed. The method can also include the step of presenting a security feature when a particular representation is selected through the selection mechanism.

Another method of selecting a profile on a multi-media device is described herein. This method can include the step of activating a scrolling mechanism presented on a display of the multi-media device, which can cause the sequential display of one or more representations of users associated with the multi-media device. The method can also include the steps of identifying a desired representation when that representation is displayed and selecting the desired representation. A profile associated with the selected representation can be activated on the multi-media device. Also, input to satisfy a security feature when selecting the representation can be provided by the user.

### BRIEF DESCRIPTION OF THE DRAWINGS

Embodiments of the present application will now be described, by way of example only, with reference to the attached Figures, wherein:

FIG. 1 illustrates an example of a multi-media device that displays a profile and a related representation of a user;

FIG. 2 illustrates an example of a block diagram of the multi-media device of FIG. 1;

FIG. 3 illustrates an example of the multi-media device of FIG. 1 displaying the profile and a related representation of another user; and

FIG. 4 illustrates an example of the multi-media device of FIG. 1 displaying the profile, the related representation of the other user of FIG. 3 and a security feature.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein.

Several definitions that apply throughout this document will now be presented. A “multi-media device” is defined as an electronic device that is capable of generating, displaying and/or broadcasting any combination of sensory-stimulating content, such as text, audio, still images, moving images, animation and interactivity. A “display” is an interface that is capable of presenting images in a form that is viewable by a human. A “housing” is a physical structure that at least partially encloses and/or provides support for one or more components. A “processor” is defined as component or a group of components that are configured to cause or direct other components to perform operations described herein. The word “representation” means a symbol that is capable of being associated with a user of a multi-media device. A “profile” is defined as a configuration of settings, parameters and/or arrangements that are associated with a particular user of a multi-media device.

As noted earlier, there are issues with providing multiple user accounts for a multi-media device. In particular, each user typically has a profile that must be accessed and loaded when a particular user desires to use the device. The description here seeks to address this concern by providing a convenient way for a user to select his/her profile among multiple profiles of the device, without complicating the operation of the device or adding significant costs.

Specifically, a multi-media device and accompanying method of selecting a user profile are described herein. The device can include a housing, a display that is integrated within the housing and a processor. The processor can be operable to cause a user interface for multiple users to be displayed on the display. The user interface can include a user indicator that selectively displays a representation of each user associated with the multi-media device and provides a selection mechanism that provides a way for a user to select a particular representation. The user interface can also include a scrolling mechanism. When activated, the scrolling mechanism can cause the user indicator to selectively display the representations of the users based on a manner in which the scrolling mechanism is activated.

Thus, a user can simply scroll through representations of the multiple users of the multi-media device and can select his/her representation for quick access to the appropriate profile. The user interface can be easily implemented into devices with multiple accounts, with limited expense and little to no effect on existing operations of the device.

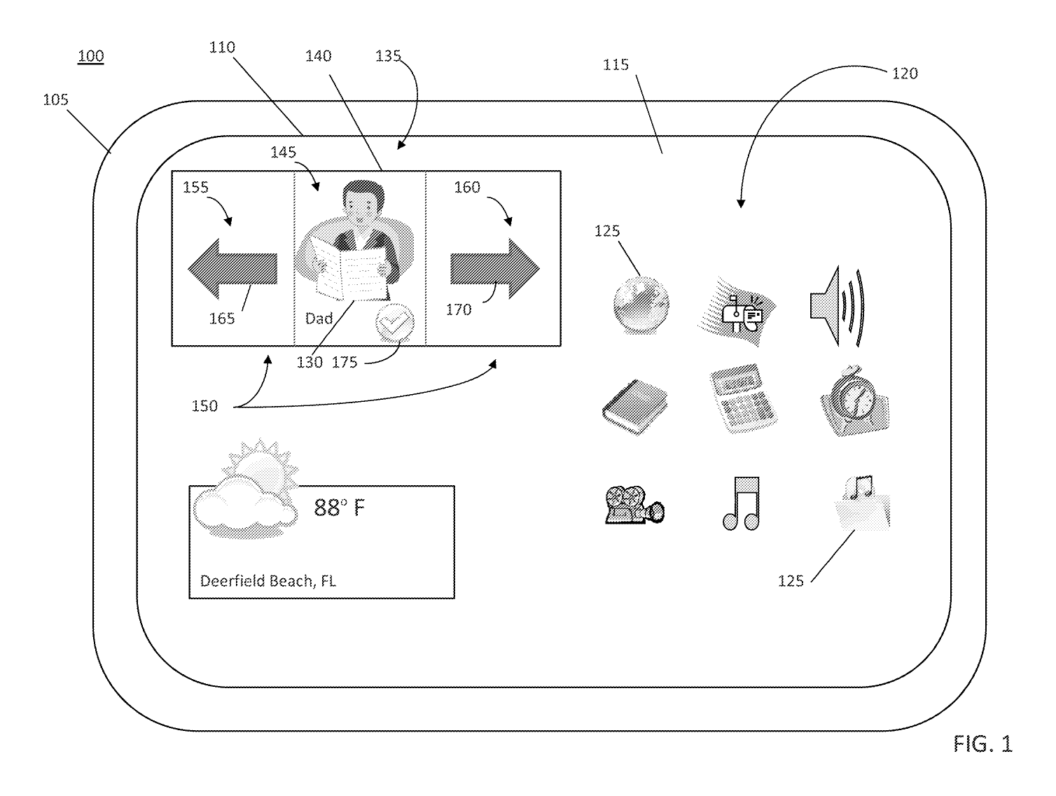

Referring to FIG. 1, an example of a multi-media device 100 is shown in which the device 100 includes a housing 105 and a display 110. As an example, the display 110 can be integrated into the housing 105, which means that at least a portion of the display 110 can be enclosed and supported by the housing 105. As an example, the display 110 can include a touch screen 115, which can receive input from any suitable object, like a finger or a stylus, through direct contact or by having the object positioned above the touch screen 115 at one or more appropriate locations. It is understood, however, that the display 110 is not necessarily limited to a touch screen, as other mechanisms can be employed for entering information into the device 100, such as through a keyboard (not shown here) or voice recognition. Multiple users may have access to the device 100, and each of these users may have associated profiles and other data saved on the device 100. The display 110 can present various types of icons, representations, text, etc., associated with these users. Examples relating to a single user are shown here. Further explanation of this information will be provided below.

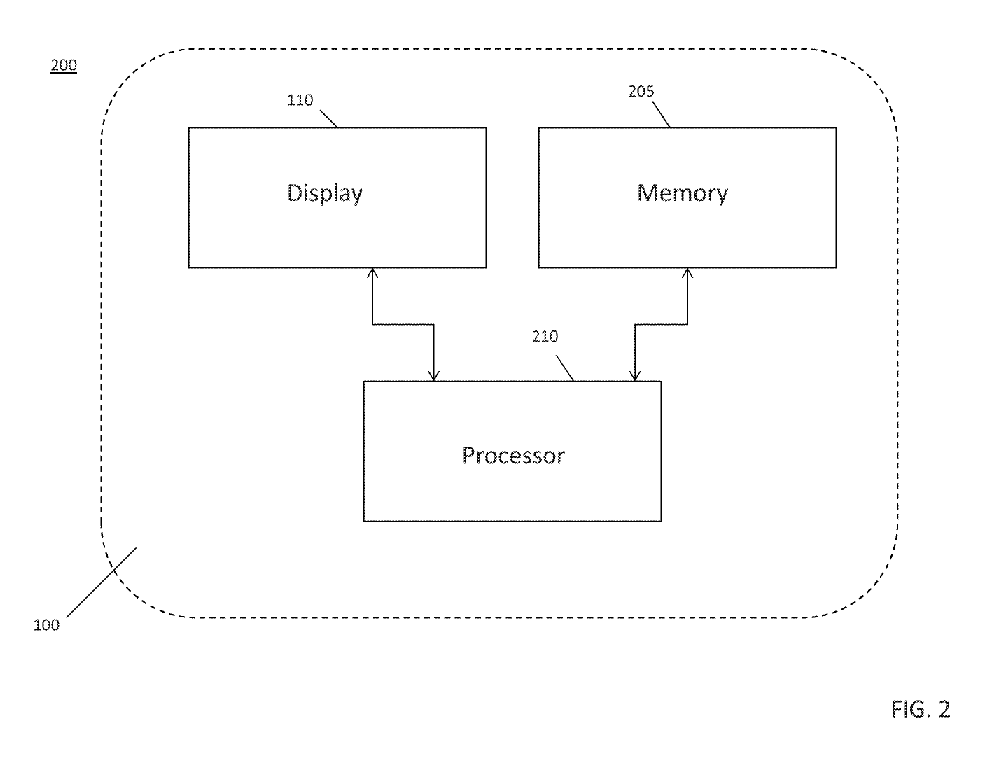

Moving to FIG. 2, a block diagram 200 that illustrates some of the components of the multi-media device 100 is shown. As pictured, the device 100 can include the display 110, a memory 205 and a processor 210, which can be coupled to both the display 110 and the memory 205. The processor 210 can be operable to cause information to be displayed on the display 110, and the memory 205 can store any suitable type of data, such as sets of instructions, to assist the processor 210 in carrying out various functions.

Referring back to FIG. 1, some of the information that can be presented on the display 110 will now be described. In this example, the device 100 has multiple users, one of whom will be referred to as “Dad,” and a profile 120 that is associated with user Dad is shown here. A profile 120 can include any settings or arrangements (including applications) that have been selected and saved by a user, and when the user accesses his/her account, the profile associated with that user can be activated. As an example, the profile 120 can be a home page that includes any number of predefined settings. The terms “cause a profile to be activated” and “activating a profile” are defined as a process in which a user is provided access to his/her profile. Exemplary icons 125 that are also associated with the profile 120 for the user Dad are presented here. The user Dad also has a representation 130, which, in this case, is an animated male figure. Of course, the representation 130 can be any symbol that can be associated with a particular user, and suitable, non-limiting examples include photographs, text, other animated objects, sounds, video, etc., whether individually or a combination of two or more.

To display the representations 130 of one or more users associated with the device 110, the processor 210 can be operable to cause the display of a user interface 135. In one arrangement, the user interface 135 can include a user indicator 140, which can selectively display the representations 130. The term “user indicator” is defined as an element that is configured to provide a medium through which a person can identify one or more representations associated with one or more users of a multi-media device. The user indicator 140 can also provide a selection mechanism 145 that can provide a way for a user to select a particular representation 130. The term “selection mechanism” is defined as a feature that enables a user to select a representation 130 for purposes of possibly being granted access to data associated with the user associated with that representation 130. As an example, the selection mechanism 145 can be part of the touch screen 115 that when activated, can initiate a corresponding action, such as the activation of a profile 120. Specifically, if a user sees his/her representation 130 displayed by the user indicator 140, the user can simply press down on the representation 130, which can cause that user's profile 120 to be activated.

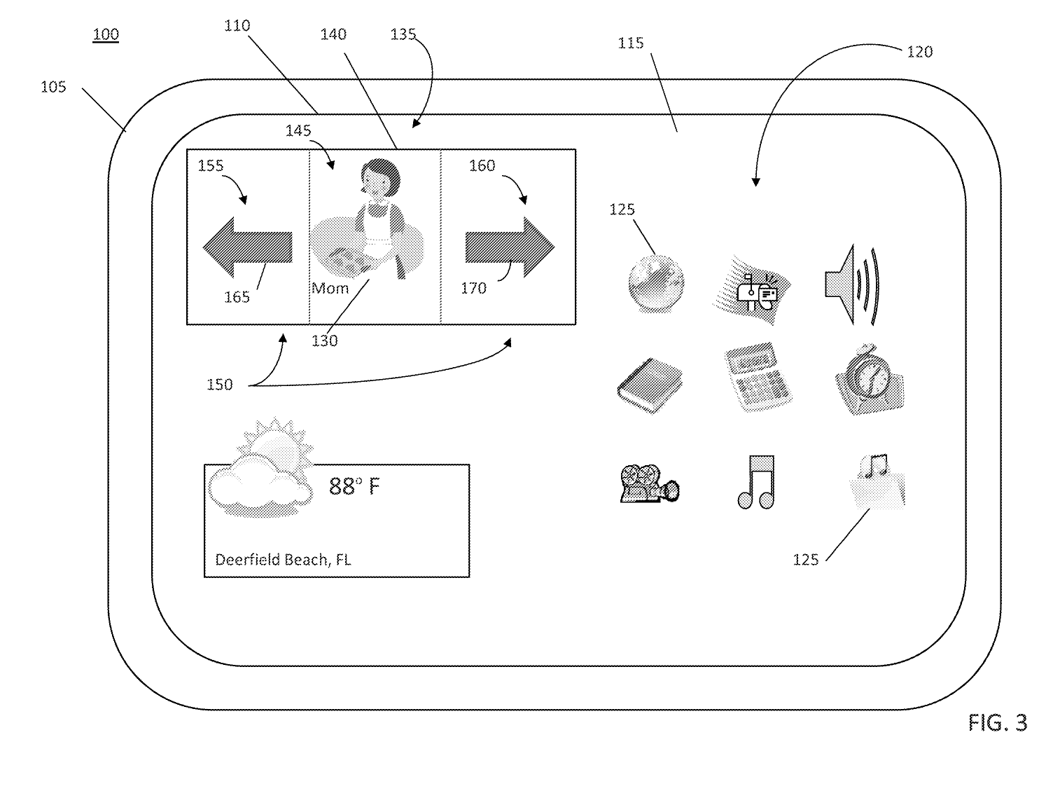

The user interface 135 can also include a scrolling mechanism 150. When activated, the scrolling mechanism 150 can cause the user indicator 140 to selectively display the representations 130 of the users of the device 100 based on a manner in which the scrolling mechanism 150 is activated. As an example, the scrolling mechanism 150 can include a set of opposing activators 155, 160 that when activated, cause the user indicator 140 to display representations 130 of the users in a manner that is associated with the activator 155, 160 that is activated. As a more specific example, the activators 155, 160 are arrowheads 165, 170 that may point in opposite directions such that when activated, a sequence of representations 130 of users is displayed in an order set by the particular arrowhead that is activated. A description that refers to both FIGS. 1 and 3 will be presented to help explain this process.

Referring to FIG. 3, an exemplary representation 130 for another user of the multi-media device 100 is shown. This user will be referred to as “Mom,” and this user's representation 130 is that of a female figure holding a tray of baked cookies. Of course, another suitable symbol may serve as the representation 130 for this user. As noted earlier, activation of the scrolling mechanism 150 may affect the display of the representations 130 by the user indicator 140. For example, assume the representation 130 of the user Dad is displayed by the user indicator 140, as shown in FIG. 1. In this case, the scrolling mechanism 150 is presented as a set of opposing arrowheads 165, 170. In one arrangement, if a user were to press down on or swipe that portion of the touch screen 115 displaying the arrowhead 170, the representation 130 associated with the user Mom can be displayed by the user indicator 140, as seen in FIG. 3. In another arrangement, subsequent presses or swipes of the arrowhead 170 can cause the user indicator 140 to display the representations 130 of other users such that the representations 130 are displayed in a sequential manner. Eventually, the display of the representations 130 can wrap around to the initial representation 130, which in this example is the representation 130 for the user Dad.

As another example, activation of an opposing activator 155, such as by pressing down on or swiping the arrowhead 165, can cause the representations 130 to be displayed in reverse sequential order, as compared to the order described above in relation to the activation of arrowhead 170. For example, referring to FIG. 3, if a user activates the arrowhead 165, then the representation 130 for the user Mom can be removed, and the one for the user Dad can be displayed (see FIG. 1).

The configuration described above can permit a user to easily scroll through the multiple representations 130 of the users of the multi-media device 100. This process can allow the user to easily locate his/her representation 130 for purposes of accessing that user's profile 120 or data on the device 100. When the appropriate representation 130 is identified, the user can select the identified representation 130 through the selection mechanism 145, such as by pressing down on the representation 130. The processor 210 can then cause the profile 120 associated with the selected representation 130 to be activated, and the user can have access to his/her settings and data.

In one arrangement, once a profile 120 has been activated, this profile 120 can remain activated until another representation 130 is selected. As such, the arrangement or other settings associated with an activated profile 120 can remain displayed until they are replaced by the activation of another profile 120. Thus, if the profile 120 associated with the user Dad is currently activated, the arrangements of this profile 120 may remain on display, even as a user scrolls through the different representations 130. That is, the currently displayed profile 120 may be associated with a representation 130 that was the last representation 130 selected through the selection mechanism 145. An example of this process is reflected in FIG. 3, wherein the representation 130 that is displayed is associated with the user Mom, although the profile 120 that is currently displayed is the one that is associated with the user Dad from FIG. 1.

To help the user identify which user is associated with the profile 120 that is currently displayed on the display 110, the user interface 135 can also include a confirmation indicator 175 (see FIG. 1). The confirmation indicator 175 can identify which of the representations 130 is associated with the activated profile 120. For example, referring to FIG. 1, the confirmation indicator 175 can be in the form of a check mark. This check mark can indicate that the activated profile 120, the one currently being displayed in FIG. 1, is associated with the representation 130 for the user Dad. When a user scrolls through the representations 130, the user can easily determine which user is associated with the profile 120 that is currently being displayed. The confirmation indicator 175 is certainly not limited to a check mark, as virtually any element can be used (text, animation, sound, tactile, etc.) to indicate to a user that an activated profile 120 is associated with a particular representation 130.

There are several other considerations to note concerning the descriptions provided above. In particular, the scrolling mechanism 150 is not limited to the embodiments that have been presented. For example, the scrolling mechanism 150 can include a single activation unit (as opposed to opposing elements) to enable a user to identify representations 130. Further, more than two activation units can be part of the scrolling mechanism 150, such as additional arrowheads respectively positioned above and below the user indicator 140. In fact, the term “scrolling mechanism” is defined as an element that permits a user to sort through a plurality of representations for purposes of identifying a particular representation. Additionally, the user indicator 140 can display multiple representations 130 simultaneously, and these multiple representations 130 can also be displayed in a sequential order. It must be noted, however, that it is not necessary to display the representations 130 in a sequential or even predefined manner.

The selection mechanism 145 is not limited to being a portion of a touch screen 115, either. Other suitable elements can be employed to enable a user to select a particular representation 130. For example, a programmable key or button or a dedicated key or button can be used to enable a selection or the device 100 can be equipped with an accelerometer to permit a user to make the selection through shaking or moving the device 100. Also, it is not necessary to require a user to even make a selection to access a profile 120. For example, a user can simply scroll through the representations 130, and as each one is displayed, the successive profiles for the displayed representations 130 can also be activated and displayed, if desired.

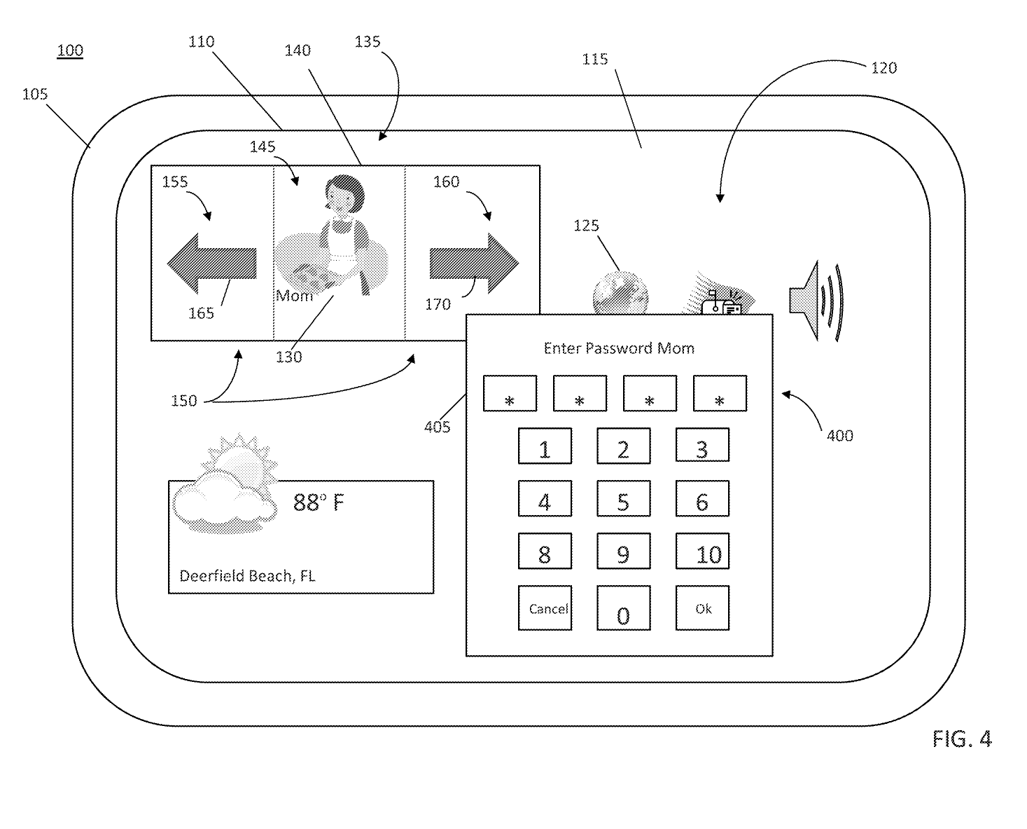

In view of multiple users having access to the multi-media device 100, certain security features can be implemented to ensure that a user's data is adequately protected. For example, referring to FIG. 4, when a particular representation 130 is selected through the selection mechanism 150, the processor 210 can cause a security feature 400 to be presented. The term “security feature” is defined as an impediment to unrestricted access to data on a multi-media device. In this example, when the representation 130 for the user Mom is selected, a keypad 405 can be displayed, which can prompt the user to enter an authorized passcode. This passcode can be associated with the selected representation 130, and the profile 120 for the selected representation 130 may not be activated until the passcode is correctly entered. Security features in addition to or in lieu of the keypad 405 may be incorporated into the device 100. For example, the user may be prompted to permit a biometric scan, like a fingerprint scan, voice recognition, iris scan, etc., to be taken to enable the relevant profile 120 to be activated.

Examples have been described above regarding a multi-media device and an accompanying method of using the device. Various modifications to and departures from the disclosed embodiments will occur to those having skill in the art. The subject matter that is intended to be within the spirit of this disclosure is set forth in the following claims.

What is claimed is:

1. A multi-media device, comprising:
a housing;
a display that is integrated within the housing; and
a processor, wherein the processor is operable to cause a user interface for multiple users to be displayed on the display, wherein the user interface includes:
a user indicator that selectively displays a representation of each user associated with the multi-media device and provides a selection mechanism that provides a way for a user to select a particular representation; and
a scrolling mechanism, wherein when activated, the scrolling mechanism causes the user indicator to selectively display the representations of the users based on a manner in which the scrolling mechanism is activated.

2. The multi-media device according to claim 1, wherein the processor is further operable to selectively cause a profile to be activated based on a representation selected through the selection mechanism.

3. The multi-media device according to claim 2, further comprising a confirmation indicator that identifies which of the representations of the users is associated with the activated profile.

4. The multi-media device according to claim 3, wherein the activated profile is a profile that is currently displayed by the display.

5. The multi-media device according to claim 4, wherein the currently displayed profile is associated with a representation that was the last representation selected through the selection mechanism.

6. The multi-media device according to claim 2, wherein the profile is a user home page that includes one or more predefined settings.

7. The multi-media device according to claim 1, wherein the scrolling mechanism comprises a set of opposing activators that when activated, cause the user indicator to display representations of the users in a manner that is associated with the activator that is activated.

8. The multi-media device according to claim 7, wherein the activators are arrowheads that point in opposite directions such that when activated, a sequence of representations of users is displayed in an order set by the particular arrowhead that is activated.

9. The multi-media device according to claim 1, wherein the processor is further operable to cause a security feature to be presented when a particular representation is selected through the selection mechanism.

10. The multi-media device according to claim 9, wherein the security feature is a prompt that seeks an authorized passcode that is associated with the particular representation that is selected.

11. A method of selecting a profile through a user interface on a multi-media device, comprising:
providing a user indicator that selectively displays a representation of one or more users associated with the multi-media device, wherein each user has a profile for the multi-media device;
providing a selection mechanism to enable a user to select a particular representation; and
providing a scrolling mechanism such that when the scrolling mechanism is activated, the user indicator selectively displays the representations of the users associated with the multi-media device based on a manner in which the scrolling mechanism is activated.

12. The method according to claim 11, further comprising activating a profile based on a representation that is selected through the selection mechanism.

13. The method according to claim 12, further comprising displaying a confirmation indicator that identifies which of the representations of the users is associated with the activated profile.

14. The method according to claim 11, wherein the scrolling mechanism comprises a set of opposing activators and the method further comprises the step of causing the user indicator to display representations of the users in a manner that is associated with the activator when at least one of the activators is activated.

15. The method according to claim 14, wherein the activators are arrowheads that point in opposite directions and the method further comprises displaying a sequence of the representations of users in an order set by a particular arrowhead when that arrowhead is activated.

16. The method according to claim 11, further comprising presenting a security feature when a particular representation is selected through the selection mechanism.

17. A method of selecting a profile on a multi-media device, comprising:
activating a scrolling mechanism presented on a display of the multi-media device, thereby causing the sequential display of one or more representations of users associated with the multi-media device;
identifying a desired representation when that representation is displayed; and
selecting the desired representation, wherein a profile associated with the selected representation is activated on the multi-media device.

18. The method according to claim 17, further comprising the step of providing input to satisfy a security feature when selecting the representation.

19. A multi-media device, comprising:
a display; and
a processor, wherein the processor is operable to cause a user interface for multiple users to be displayed on the display, wherein the user interface includes:
a user indicator that selectively displays a representation of one or more users associated with the multi-media device and provides a selection mechanism that provides a way for a user to select a particular representation; and
a scrolling mechanism, wherein when activated, the scrolling mechanism causes the user indicator to selectively display the representations of the users based on a manner in which the scrolling mechanism is activated.
